(19) United States
(12) Patent Application Publication
(10) Pub. No.: US 2023/0325710 A1
(43) Pub. Date: Oct. 12, 2023

(54) LEARNING DEVICE, LEARNING METHOD AND LEARNING PROGRAM

(71) Applicant: NIPPON TELEGRAPH AND TELEPHONE CORPORATION, Tokyo (JP)

(72) Inventor: Masanori YAMADA, Musashino-shi, Tokyo (JP)

(73) Assignee: NIPPON TELEGRAPH AND TELEPHONE CORPORATION, Tokyo (JP)

(21) Appl. No.: 18/024,512

(22) PCT Filed: Sep. 15, 2020
(86) PCT No.: PCT/JP2020/034986

§ 371 Date: Mar. 3, 2023

(51) Int. Cl. G06N 20/00

(52) U.S. Cl. CPC G06N 20/00

(57) ABSTRACT

An acquisition unit acquires data for which a label is to be predicted. A learning unit learns a model representing a probability distribution of a label of the acquired data by using, as a filter, a correct answer label of the data so as to correctly predict a label for an adversarial example in which noise is added to the data.

### TECHNICAL FIELD

The present invention relates to a learning apparatus, a learning method, and a learning program.

### BACKGROUND ART

In recent years, machine learning has achieved great success. In particular, machine learning has become a mainstream method in the fields of images and natural languages with the appearance of deep learning.

On the other hand, it is known that deep learning is vulnerable to attacks from an adversarial example in which malicious noise is added. As an effective countermeasure against such an adversarial example, a technique called tradeoff-inspired adversarial defense via surrogate-loss minimization (TRADES) using a proxy loss has been proposed (refer to Non Patent Literatures 1 and 2).

### CITATION LIST

### Non Patent Literature

Non Patent Literature 1: A. Madry et al., “Towards Deep Learning Models Resistant to Adversarial Attacks”, [online], arXiv:1706.06083v4 [stat.ML], September, 2019, [retrieved Aug. 19, 2020], Internet <URL: https://arxiv.org/pdf/1706.06083.pdf>
Non Patent Literature 2: H. Zhang et al., “Theoretically Principled Trade-off between Robustness and Accuracy”, [online], arXiv:1901.08573v3 [cs.LG], June, 2019, [retrieved Aug. 19, 2020], Internet <URL: https://arxiv.org/pdf/1901.08573.pdf>

### SUMMARY OF INVENTION

### Technical Problem

However, in TRADES in the related art, it may be difficult to improve generalization performance for the adversarial example. That is, in TRADES, a loss function is approximated and minimized to an upper bound which can be calculated, and as a result, there are cases where the loss function is not approximated to a sufficiently low upper bound and the generalization performance deteriorates.

The present invention has been made in view of the above, and an object of the present invention is to learn a model that is robust to the adversarial example.

### Solution to Problem

In order to solve the above-described problems and achieve the object, according to the present invention, there is provided a learning apparatus including: an acquisition unit that acquires data for which a label is to be predicted; and a learning unit that learns a model representing a probability distribution of a label of the acquired data by using, as a filter, a correct answer label of the data so as to correctly predict a label for an adversarial example in which noise is added to the data.

### Advantageous Effects of Invention

According to the present invention, it is possible to learn a model that is robust to the adversarial example.

### BRIEF DESCRIPTION OF DRAWINGS

FIG. 1 is a schematic diagram illustrating a schematic configuration of a learning apparatus.

FIG. 2 is a flowchart illustrating a learning processing procedure.

FIG. 3 is a flowchart illustrating a detection processing procedure.

FIG. 4 is a diagram for explaining an example.

FIG. 5 is a diagram for explaining an example.

FIG. 6 is a diagram for explaining an example.

FIG. 7 is a diagram for explaining an example.

FIG. 8 is a diagram illustrating a computer that executes a learning program.

### DESCRIPTION OF EMBODIMENTS

Hereinafter, an embodiment of the present invention will be described in detail with reference to the drawings. Note that the present invention is not limited by the embodiment. Further, in the description of the drawings, the same portions are denoted by the same reference numerals.

### [Configuration of Learning Apparatus]

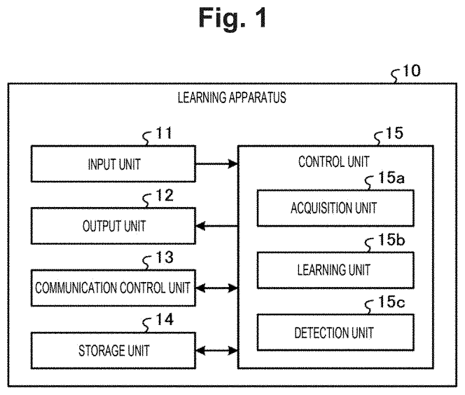

FIG. 1 is a schematic diagram illustrating a schematic configuration of a learning apparatus. As illustrated in FIG. 1, a learning apparatus 10 is realized by a general-purpose computer such as a personal computer, and includes an input unit 11, an output unit 12, a communication control unit 13, a storage unit 14, and a control unit 15.

The input unit 11 is realized by using an input device such as a keyboard and a mouse, and inputs various kinds of instruction information such as a processing start to the control unit 15 in response to input operations of an operator. The output unit 12 is realized by a display device such as a liquid crystal display, a printing device such as a printer, or the like.

The communication control unit 13 is realized by a network interface card (NIC) or the like, and controls communication between the control unit 15 and an external apparatus such as a server via a network. For example, the communication control unit 13 controls communication between the control unit 15 and a management apparatus or the like that manages data to be learned.

The storage unit 14 is realized by a semiconductor memory element such as a random access memory (RAM) or a flash memory or a storage device such as a hard disk or an optical disk, and stores parameters and the like of a model learned by learning processing to be described later. Note that the storage unit 14 may be configured to perform communication with the control unit 15 via the communication control unit 13.

The control unit 15 is realized by using a central processing unit (CPU) or the like, and executes a processing program stored in a memory. Thereby, the control unit 15 functions as an acquisition unit 15a, a learning unit 15b, and a detection unit 15c as illustrated in FIG. 1. Note that each or some of these functional units may be provided in different hardware. For example, the learning unit 15b and the detection unit 15c may be provided as separate devices. Alternatively, the acquisition unit 15a may be provided in a device different from a device in which the learning unit 15b and the detection unit 15c are provided. Further, the control unit 15 may include other functional units.

The acquisition unit 15a acquires data for predicting a label. For example, the acquisition unit 15a acquires data to be used for learning processing and detection processing to be described later via the input unit 11 or the communication control unit 13. In addition, the acquisition unit 15a may store the acquired data in the storage unit 14. Note that the acquisition unit 15a may transmit the information to the learning unit 15b or the detection unit 15c without storing the information in the storage unit 14.

The learning unit 15b learns a model representing a probability distribution of a label of the acquired data so as to correctly predict a label for an adversarial example in which noise is added to the data, by using, as a filter, a correct answer label of the data. Specifically, the learning unit 15b learns the model by searching for a model that minimizes a loss function.

Here, a model representing a probability distribution of a label y of data x is expressed by the following Equation (1) using a parameter θ. f is a vector representing a label which is output by the model.

$$\begin{matrix}[ Equation 1 ] & \\ {p}_{θ} ( {y}_{k} \vert x ) = \frac{exp {f}_{k} ( x ; θ )}{{\sum }_{i} exp {f}_{i} ( x ; θ )} & ( 1 )\end{matrix}$$

The learning unit 15b learns the model by determining the parameter θ of the model such that the loss function expressed by the following Equation (2) is decreased. Here, p(y|x) represents a true probability.

[Equation 2]

l(x,y;θ)=p(y|x)log p_{θ}(y|x) (2)

Further, the learning unit 15b learns the model so as to correctly predict a label for the adversarial example in which noise η is added to the data x and which is expressed by the following Equation (3).

$$\begin{matrix}[ Equation 3 ] & \\ {max}_{η} {E}_{x , y \sim p ( x , y )} [ l ( x + η , y ; θ ) ] & ( 3 )\end{matrix}$$

In TRADES, a model that is robust to the adversarial example is learned by searching for and determining θ that minimizes the loss function expressed by the following Equation (4). Note that D is a constant.

$$\begin{matrix}[ Equation 4 ] & \\ loss = - [ l ( x , y ; θ ) ] + β {max}_{{x}^{′} ∈ ( x , ϵ )} {D}_{KL} ( {p}_{θ} ( y \vert x ) \vert \vert {p}_{θ} ( y \vert {x}^{′} ) ) & ( 4 )\end{matrix}$$

Here, as expressed in the following Equation (5), a natural error Rₙₐₜ(f), a robust error R_{rob}(f), and a boundary error R_{bdy}(f) are defined. Note that, in the following Equation (5), 1(*) is an indication function that indicates 1 in a case where the content * is true and indicates 0 in a case where the content * is false.

$$\begin{matrix}[ Equation 5 ] & \\ ( f ) := 1 \{ f ( X ) Y \leq 0 \} \\ ( f ) := 1 \{ {X}^{′} ∈ ( X , e ) s . t . f ( {X}^{′} ) Y \leq 0 \} \\ ( f ) := 1 \{ X ∈ ( DB ( f ) , e ) , f ( X ) Y > 0 \} & ( 5 )\end{matrix}$$

### Here,

[symbol] (X,ϵ)≡{x|x′∈ [symbol] :∥x′−x∥≤ε}

[symbol]

(DB(f),ϵ)≡{x|x∈X: [symbol] x′∈ [symbol] (x,ϵ) s.t. f(x)f(x′)≤0}

Further, these relationships are expressed by the following Equation (6). Therefore, it can be seen that a model which is robust to the adversarial example is obtained in a case where the robust error is reduced.

[Equation 6]

[symbol]

(f)= [symbol] (f)+ [symbol] (f) (6)

Here, it is known that the following Equation (7) is established (refer to Non Patent Literature 2).

### [Equation 7]

$$\begin{matrix}[ Equation 7 ] & \\ ( f ) - \leq - [ l ( x , ; θ ) ] + [ 1 ( y = arg {max}_{i} {f}_{i} ( x ) ) 1 ( x ∈ ( DB ( f ) , e ) ) ] & ( 7 )\end{matrix}$$

For a second term of Equation (7), the following Equation (8) is established.

$$\begin{matrix}[ Equation 8 ] & \\ [ 1 ( y = arg {max}_{i} {f}_{i} ( x ) ) 1 ( x ∈ ( DB ( f ) , e ) ) ] = 𝔼 \text{?} 1 \{ arg {max}_{i} {f}_{i} ( {x}^{′} ) \neq arg {max}_{i} {f}_{i} ( x ) \} 1 ( y = arg {max}_{i} {f}_{i} ( x ) ) \sim 𝔼 \text{?} {D}_{KL} ( p ( Y \vert X ) \vert \vert p ( Y \vert {X}^{′} ) ) 1 ( y = arg {max}_{i} {f}_{i} ( x ) ) \leq 𝔼 \text{?} {D}_{KL} ( p ( Y \vert X ) \vert \vert p ( Y \vert {X}^{′} ) ) & ( 8 )\end{matrix}$$

$$\text{?} \text{indicates text missing or illegible when filed}$$

Thus, the learning unit 15b sets the loss function as the following Equation (9) (hereinafter, this method is referred to as “1+loss”). Thereby, as can be seen from a third row and a fourth row of Equation (8), an upper bound becomes stricter than in the loss function in the related art that is expressed by Equation (4). Therefore, it is possible to learn a model that is more robust to the adversarial example than in the related art.

$$\begin{matrix}[ Equation 9 ] & \\ loss = - [ l ( x , ; θ ) ] + β {max}_{{x}^{′} ∈ 𝔹 ( x , ϵ )} {D}_{KL} ( {p}_{θ} ( y \vert x ) \vert \vert {p}_{θ} ( y \vert {x}^{′} ) ) 1 ( y = arg {max}_{i} {f}_{i} ( x ; θ ) ) & ( 9 )\end{matrix}$$

The method according to Equation (9) means that, in the loss function, a filter limited only to the correct answer label of the data x is applied to a second term related to the adversarial example in which noise is added to the data x. Thereby, in TRADES which is a method of adjusting a trade-off between a correct answer rate by normal data and an achievement rate by the adversarial example, it is possible to omit unnecessary data that cannot be correctly predicted from the beginning.

Further, the learning unit 15b may replace the filter represented by the indication function of Equation (9) with a probability of a correct answer label as in the following Equation (10) (hereinafter, this method is referred to as “p+loss”). Thereby, an upper bound also becomes stricter than in the loss function in the related art.

$$\begin{matrix}[ Equation 10 ] & \\ loss = - [ l ( x , ; θ ) ] + β𝔼 {max}_{{x}^{′} ∈ 𝔹 ( x , ϵ )} {D}_{KL} ( {p}_{θ} ( y \vert x ) \vert \vert {p}_{θ} ( y \vert {x}^{′} ) ) ( {\sum }_{i} {p}_{θ} ( {y}_{i} \vert x ) p ( {y}_{i} \vert x ) ) & ( 10 )\end{matrix}$$

Further, in order to minimize the loss function of (10), the learning unit 15b searches for a second term of Equation (10) by a gradient method. Thus, the learning unit 15b may minimize a probability distribution of a label of the data, as a fixed value, in the loss function for the adversarial example. That is, the learning unit 15b may exclude the second term of Equation (10) from optimization targets of the loss function by the gradient method (hereinafter, this method is referred to as “fixed p+loss”). Specifically, the learning unit 15b searches for the second term of Equation (10) in a state where p_{θ} is fixed. Thereby, it is possible to efficiently optimize the loss function by excluding a case where p_{θ} is close to 0.

The detection unit 15c predicts a label of the acquired data by using the learned model. In this case, the detection unit 15c calculates a probability of each label of newly acquired data by applying the learned parameter θ to Equation (1), and outputs a label having a highest probability. Thereby, it is possible to output a correct label even in a case where, for example, the data corresponds to the adversarial example. In this way, the detection unit 15c can predict a correct label for the adversarial example that withstands a blind spot attack.

### [Learning Processing]

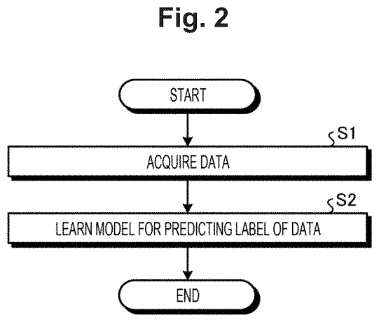

Next, learning processing performed by the learning apparatus 10 according to the present embodiment will be described with reference to FIG. 2. FIG. 2 is a flowchart illustrating a learning processing procedure. The flowchart of FIG. 2 is started, for example, at a timing when an operation for instructing a start of learning processing is input.

First, the acquisition unit 15a acquires data for which a label is to be predicted (step S1).

Next, the learning unit 15b learns a model representing a probability distribution of a label of the acquired data (step S2). At this time, the learning unit 15b learns the model so as to correctly predict a label for an adversarial example in which noise is added to the data, by using, as a filter, a correct answer label of the data. Thereby, the series of learning processing ends.

### [Detection Processing]

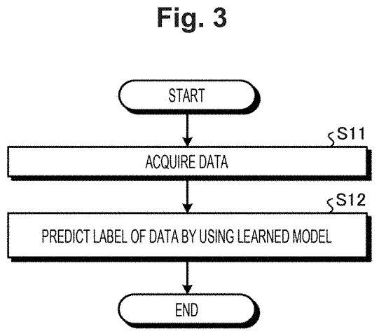

Next, detection processing performed by the learning apparatus 10 according to the present embodiment will be described with reference to FIG. 3. FIG. 3 is a flowchart illustrating a detection processing procedure. The flowchart of FIG. 3 is started, for example, at a timing when an operation for instructing a start of detection processing is input.

First, the acquisition unit 15a acquires new data for which a label is to be predicted as in the processing in step S1 of FIG. 2 described above (step S11).

Next, the detection unit 15c predicts a label of the acquired data by using the learned model (step S12). In this case, the detection unit 15c calculates p(x′) of newly acquired data x′ by applying the learned parameter e to Equation (1), and outputs a label having a highest probability. Thus, for example, even in a case where the data x′ corresponds to an adversarial example, it is possible to output a correct label. Thereby, the series of detection processing ends.

As described above, the acquisition unit 15a acquires data for which a label is to be predicted. Further, the learning unit 15b learns a model representing a probability distribution of a label of the acquired data so as to correctly predict a label for an adversarial example in which noise is added to the data, by using, as a filter, a correct answer label of the data.

Thereby, the learning apparatus 10 can learn a model that is robust to the adversarial example by approximating the loss function in the strict upper bound.

In addition, the learning unit 15b minimizes a probability distribution of a label of the data, as a fixed value, in the loss function for the adversarial example. Thereby, the learning apparatus 10 can efficiently perform optimization of the loss function by the gradient method.

Further, the detection unit 15c predicts a label of the acquired data by using the learned model. Thereby, the detection unit 15c also can predict a correct label for the adversarial example that withstands a blind spot attack.

### Examples

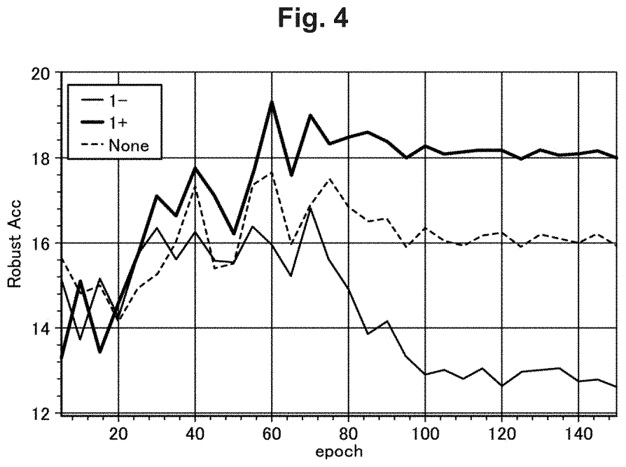

FIG. 4 to FIG. 7 are diagrams for explaining examples of the present invention. In the present example, accuracy of the model according to the embodiment is evaluated by using an image data set of Cifar 10 and a deep learning model of Resnet 18. Specifically, the model according to the embodiment and a model according to a method in the related art are learned by the loss function, and are evaluated by using test data and an adversarial example generated from the test data by a method in the related art that is called PGD.

As parameters of PGD, esp=8/255, train_iter=10, eval_iter=20, eps_iter=0.031, rand_init=True, clip_min=0.0, and clip_max=1.0 are used.

Then, a correct answer rate (hereinafter referred to as natural acc) of top1 with respect to the test data and a correct answer rate (an achievement rate, hereinafter referred to as robust acc) of top1 with respect to the adversarial example generated from the test data are calculated.

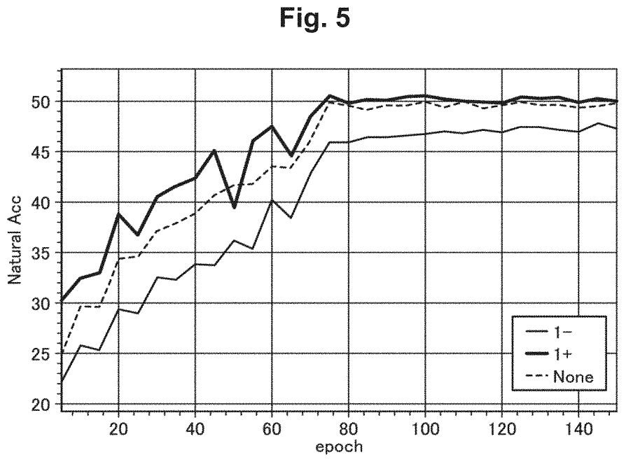

First, FIG. 4 and FIG. 5 illustrate an effect of the filter corresponding to the correct answer label added to the second term of the loss function according to the embodiment. Here, among pieces of normal data to which noise is not added, a set S⁺ of pieces of data to which correct answer labels are given and a set S⁻ of pieces of data to which incorrect answer labels are given are set to be the same size by sampling, and a set S obtained by combining the two sets is generated.

For the set S, a model (None in FIG. 4 and FIG. 5) learned by a method in the related art, a model (1+ in FIG. 4 and FIG. 5) learned by the method “1+loss,” and a model (1− in FIG. 4 and FIG. 5) learned using pieces of data having incorrect answer labels are used, the incorrect answer labels being 0 in a case where the indication function is true and being 1 in a case where the indication function is false. Then, the robust acc and the natural acc according to each method are calculated.

FIG. 4 illustrates a change by learning of the robust acc of each model. In addition, FIG. 5 illustrates a change by learning of the natural acc of each model. As illustrated in FIG. 4, it is confirmed that the model according to the method 1+ contributes to improvement of the robust acc as compared with the model according to the method in the related art.

On the other hand, it can be seen that the model according to the method 1− inhibits improvement of the robust acc. In addition, as illustrated in FIG. 5, it can be seen that the model according to the method 1− inhibits improvement of the natural acc. This is because TRADES is a method of adjusting a trade-off between the robust acc and the natural acc and thus the method 1− uses unnecessary data that cannot be correctly predicted from the beginning.

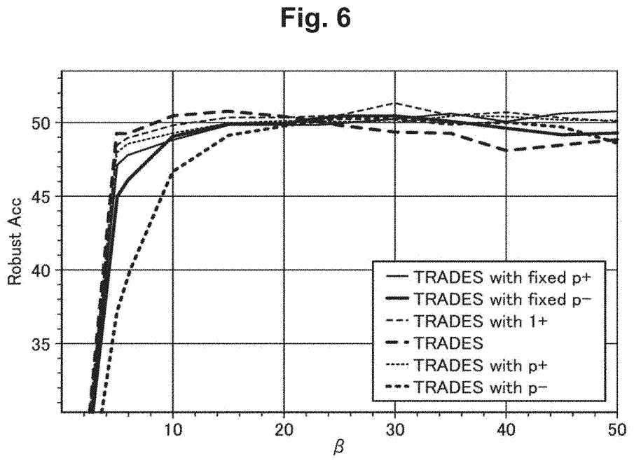

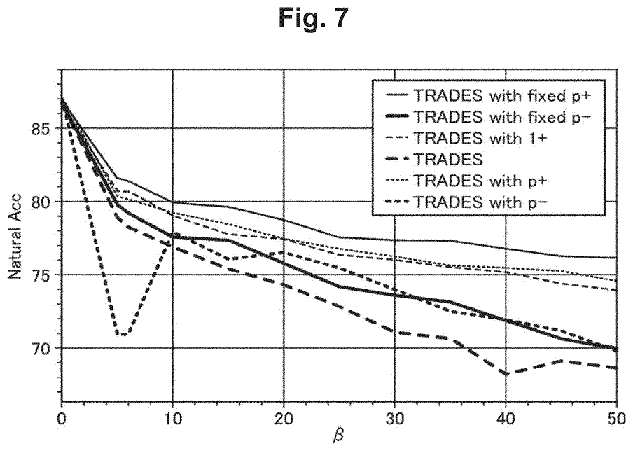

Further, FIG. 6 illustrates a relationship between the robust acc and Q of the model according to each method. In addition, FIG. 7 illustrates a relationship between the natural acc and β of the model according to each method. Here, p+ is the method “p+loss” according to the embodiment. Further, p− is 1−(p+). Further, fixed p+ is a method “fixed p+ loss” according to the embodiment. Further, fixed p− is 1−(fixed p+).

As illustrated in FIG. 6, it can be seen that, in both the model according to the method in the related art (TRADES in FIG. 6) and the model according to the present invention (TRADES with 1+, TRADES with p+, and TRADES with fixed p+ in FIG. 6), prediction accuracy for the adversarial example does not depend on P. On the other hand, as illustrated in FIG. 7, in both the model according to the method in the related art and the model according to the present invention, as β increases, prediction accuracy for normal data is lowered. This is because the first item of the loss function is a part representing a loss function for normal data and the second item of the loss function is a part representing a loss function for the adversarial example and thus the second item has a greater influence as β increases.

Therefore, B in a case where the robust acc is high is adopted, and accuracy of the model according to the method in the related art and accuracy of the model according to the method “1+loss” are compared. As a result, in the model according to the method in the related art, β=20, Robust Acc=50.74, and Natural Acc=75.39. Further, in the model according to the method “1+loss” of the present embodiment, β=10, Robust Acc=51.3, and Natural Acc=76.01. In this way, it is confirmed that the model according to the present embodiment has a slightly higher robust acc than the model according to the method in the related art. In addition, it is confirmed that the model according to the present embodiment does not impair the natural acc as much as the method in the related art even in a case where is changed. In this way, it is confirmed that, in the model according to the embodiment, a model which is robust to the adversarial example can be learned in accordance with the second item of the loss function.

### [Program]

It is also possible to create a program in which the processing to be executed by the learning apparatus 10 according to the embodiment is described in a language that can be executed by a computer. In an embodiment, the learning apparatus 10 can be implemented by installing a learning program for executing the learning processing as packaged software or online software in a desired computer. For example, by causing an information processing apparatus to execute the learning program, the information processing apparatus can be caused to function as the learning apparatus 10. Further, the information processing apparatus includes mobile communication terminals such as a smartphone, a mobile phone, and a personal handyphone system (PHS) in addition to the computer, and further includes a slate terminal such as a personal digital assistant (PDA). Further, the functions of the learning apparatus 10 may be implemented in a cloud server.

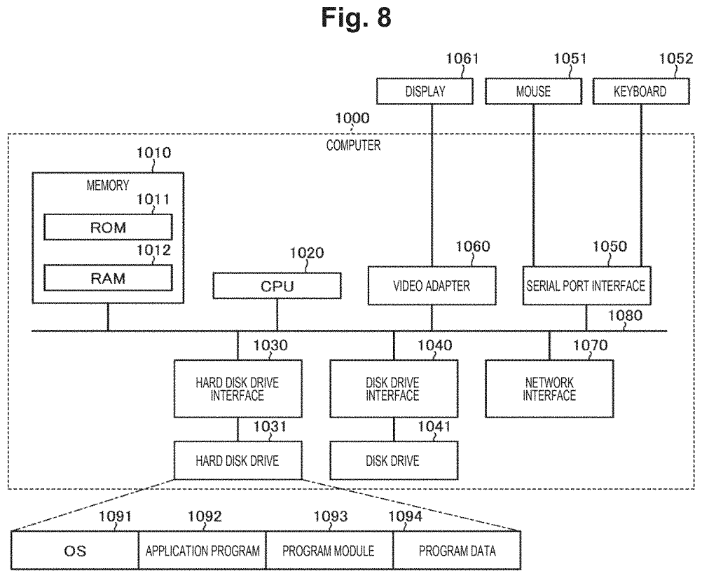

FIG. 8 is a diagram illustrating an example of a computer that executes a learning program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. For example, a mouse 1051 and a keyboard 1052 are connected to the serial port interface 1050. For example, a display 1061 is connected to the video adapter 1060.

Here, the hard disk drive 1031 stores, for example, an OS 1091, an application program 1092, a program module 1093, and program data 1094. All information described in the embodiment is stored, for example, in the hard disk drive 1031 or the memory 1010.

In addition, the learning program is stored in the hard disk drive 1031, for example, as a program module 1093 in which commands to be executed by the computer 1000 are described. Specifically, the program module 1093 in which all of the processing to be executed by the learning apparatus 10 described in the embodiment is described is stored in the hard disk drive 1031.

Further, data to be used for information processing performed by the learning program is stored as the program data 1094, for example, in the hard disk drive 1031. Then, the CPU 1020 reads, into the RAM 1012, the program module 1093 and the program data 1094 stored in the hard disk drive 1031 as necessary, and executes each procedure described above.

Note that the program module 1093 and the program data 1094 related to the learning program are not limited to a case of being stored in the hard disk drive 1031. For example, the program module 1093 and the program data 1094 may be stored in a removable storage medium, and may be read by the CPU 1020 via the disk drive 1041 or the like. Alternatively, the program module 1093 and the program data 1094 related to the learning program may be stored in another computer connected via a network such as a local area network (LAN) or a wide area network (WAN), and may be read by the CPU 1020 via the network interface 1070.

Although the embodiment to which the invention made by the present inventor is applied has been described above, the present invention is not limited by the description and the drawings according to the present embodiment as a part of the disclosure of the present invention. In other words, other embodiments, examples, operation techniques, and the like made by those skilled in the art or the like based on the present embodiment are all included in the scope of the present invention.

### REFERENCE SIGNS LIST

10 Learning apparatus
11 Input unit
12 Output unit
13 Communication control unit
14 Storage unit
15 Control unit
15a Acquisition unit
15b Learning unit
15c Detection unit

1. A learning apparatus comprising:
a memory; and
a processor coupled to the memory and programmed to execute a process comprising:
acquiring data for which a label is to be predicted; and
learning a model representing a probability distribution of a label of the acquired data by using, as a filter, a correct answer label of the data so as to correctly predict a label for an adversarial example in which noise is added to the data.

2. The learning apparatus according to claim 1, wherein the learning minimizes a probability distribution of a label of the data to a fixed value in a loss function for the adversarial example.

3. The learning apparatus according to claim 1, further comprising predicting a label of the acquired data by using the learned model.

4. A learning method executed by a learning apparatus, the method comprising:
an acquisition step of acquiring data for which a label is to be predicted; and
a learning step of learning a model representing a probability distribution of a label of the acquired data by using, as a filter, a correct answer label of the data so as to correctly predict a label for an adversarial example in which noise is added to the data.

5. A computer-readable recording medium having stored a learning program causing a computer to execute a process comprising:
an acquisition step of acquiring data for which a label is to be predicted; and
a learning step of learning a model representing a probability distribution of a label of the acquired data by using, as a filter, a correct answer label of the data so as to correctly predict a label for an adversarial example in which noise is added to the data.
